(19) United States
(12) Patent Application Publication
(10) Pub. No.: US 2006/0200517 A1
(43) Pub. Date: Sep. 7, 2006

(54) Method and apparatus for real time multi-party conference document copier

(76) Inventors: Steve Nelson, San Jose, CA (US); Victor Ivashin, Danville, CA (US); Chia-Hsin Li, San Jose, CA (US)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/073,064

(22) Filed: Mar. 3, 2005

(51) Int. Cl. G06F 15/16

(52) U.S. Cl. 709/204

(57) ABSTRACT

A document exchange device for assistance with an audio/video conferencing session includes an image capture component configured generate a scanned image of a document and an output component configured to provide a printed image of the document. A user interface of the document exchange device is configured to display connection information that includes whether the device is connected to a document exchange session associated with the conferencing session. A list of documents exchanged during the document exchange session and a list of other document exchange devices connected to the document exchange session are also included in the information displayed by the user interface. A data network connection port is included to enable external communication. A system providing a document exchange session for a conferencing session and a method for exchanging documents during a conference session are also provided.

### CROSS REFERENCE TO RELATED APPLICATIONS

This application is related to the following U.S. Patent Applications: (1) Ser. No. 10/440,526, filed on May 16, 2003, and entitled “Annotation Management System”; (2) Ser. No. 10/935,980, filed on Sep. 8, 2004, and entitled “Network Connection Through NAT Routers and Firewall Devices”; and (3) Ser. No. 10/681,523, filed on Oct. 8, 2003, and entitled “Method and Apparatus for Tunneling Data Through a Single Port.” These applications are incorporated by reference herein in their entirety for all purposes.

### BACKGROUND

1. Field of the Invention

This invention relates generally to videoconferencing systems and more particularly to the real time exchange of hard-copy documents during a conference.

2. Description of the Related Art

Conferencing devices are used to facilitate communication between two or more participants physically located at separate locations. Devices are available to exchange live video, audio, and other data, which the participants may view, hear, and/or otherwise use to collaborate with each other. Common applications for conferencing include meetings/workgroups, presentations, and training/education. Today, with the help of videoconferencing software, a personal computer with an inexpensive camera and microphone can be used to connect with other conferencing participants. The operating systems of some of these machines provide simple peer-to-peer videoconferencing software, such as MICROSOFT'S NETMEETING application that is included with MICROSOFT WINDOWS based operating systems. Alternatively, peer-to-peer videoconferencing software applications can be inexpensively purchased separately. Motivated by the availability of software and inexpensive camera/microphone devices, videoconferencing has become increasingly popular. As videoconferencing software has gained popularity, more and more companies are turning to virtual meetings conducted over the web to cut costs of flying employees to meet face to face.

During the course of real-time communication between remote parties (i.e. as in a telephone conference or a videoconference), the exchange of hard-copy documents is often desired or essential. Traditional methods of document conveyance have various shortcomings for an ad hoc meeting. Courier/mail delivery is too slow to meet the real-time requirements of the exchange. As a result, electronic methods have been developed and employed. However, these methods too are limited. Typically they deliver poor quality results, e.g., a facsimile, are not well managed/controlled, or require complex user operations, and higher-cost equipment.

Fax machines are popular hard-copy transfer devices. They are quite inexpensive today and are generally easy to use. However, faxing remains an older technology with long transfer times, low document resolution / quality, and is not generally color capable. Fax machines are also only point-to-point devices. Sending hard-copy documents to multiple parties requires rescanning and resending of the document data for each recipient. The fax machine is also not a well-managed device. Anyone holding a fax machine's phone number can send documents to the device without authorization. Moreover, most fax machines cannot simultaneously send a document while receiving another.

With DSL, wireless, cable and other network technologies, hard-copy documents can be transferred in other electronic forms, such as in the form of an attachment to an email or as a binary transfer. These solutions require a data network, but unlike a facsimile, the transfer protocols can scale with the network speed. These solutions can also achieve higher quality as the full detail of the electronic version of the document can be transferred. However, these solutions depend much more on increasingly complex user operations and additional hardware. The source participant must first create an electronic version of the hard-copy document through a scanning or other capture operation. A computer is often necessary for this process and to facilitate in the transfer step. The target participants generally must also have computers or similar devices for receipt of the electronic document. They may also require specific target software to decode the electronic file-type being exchanged. A connected printer is also needed for obtaining hard-copy output. Multiple operations are thus required to initiate the hard copy to electronic conversion, to facilitate the send and receive transfer process, and to control the print output method. The source participant and each target recipient all have functions to perform. If the document is to be used by multiple recipients, each must perform the same steps to ensure consistent hard-copy output that may be necessary for the real-time communication (i.e. print driver settings for color matching). These tasks can greatly detract and interrupt the real-time exchange.

As a result, there is a need for a device that is easy to interconnect with multiple similar devices in an ad hoc manner during a real-time conference and facilitate the exchange of hard-copy documents among the participants.

### SUMMARY

Broadly speaking, the present invention fills these needs by providing a method and system enabling the simple ad-hoc connection of devices for the real time exchange of hard-copy documents. It should be appreciated that the present invention can be implemented in numerous ways, including as a process, a system, a computer readable media, or a graphical user interface. Several inventive embodiments of the present invention are described below.

In one embodiment, a system providing a document exchange session for a conferencing session is provided. The system includes a plurality of document capturing devices, at least one of which is associated with each client of the conferencing session. A meeting media server configured to store document data from any of the plurality of document capturing devices and transfer document data among the plurality of document capturing devices is included. A registration service device in communication with each of the plurality of document capturing devices is provided. The registration service device is configured to process requests from the plurality of document capturing devices to identify the corresponding document exchange session. The registration service device includes a meeting dispatcher service component configured to handle document exchange session creation and a meeting load balancer component configured to allocate space on the meeting media server for the document exchange session according to meeting media server activity.

In another embodiment, a document exchange device for assistance with an audio/video conferencing session is provided. The document exchange device includes an image capture component configured generate a scanned image of a document to be transmitted. An output component configured to provide a printed image of a received document is included within the device. A user interface configured to display connection information is also included. The connection information includes whether the device is connected to a document exchange session associated with the conferencing session, a list of documents exchanged during the document exchange session, and a list of other document exchange devices connected to the document exchange session. A data network connection port is included with the device for external communication.

In yet another embodiment, a method for exchanging documents during a conference session is provided. The method initiates with identifying a document to be exchanged between the conference session participants. Then, a document exchange meeting session is created through a document exchange device of one of the conference session participants. The document is scanned through the document exchange device and each of the remaining document exchange devices is simultaneously notified of the availability of the document. The document is retrieved through each of the remaining document exchange devices in response to receiving notification of availability of the document.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified schematic diagram of a system in which document exchange devices are interconnected in order to exchange documents in an add-hoc manner during a real-time conference in accordance with one embodiment of the invention.

FIG. 2 is a flow chart diagram illustrating the method operations for creating a meeting through a document exchange device in accordance with one embodiment of the invention.

FIG. 3 is a flow chart diagram illustrating the method operations for additional participants to connect to a document exchange session once the session has been created in accordance with one embodiment of the invention.

FIG. 4 is a flow chart diagram illustrating the method operations in which a document exchange device may copy, reprint, or disconnect from a meeting in accordance with one embodiment of the invention.

FIG. 5 is a simplified schematic diagram of an exemplary user interface, which is displayed on a document exchange device in accordance with one embodiment of the invention.

FIG. 6 is an alternative user interface, which may be incorporated onto a document exchange device in accordance with one embodiment of the invention.

FIG. 7 is a simplified schematic diagram of an exemplary application layout in accordance with one embodiment of the invention.

FIG. 8 is a simplified schematic diagram illustrating a component container cell designed to contain a component in accordance with one embodiment of the invention.

FIG. 9 is a simplified schematic diagram illustrating the configuration of the components of an interface, in accordance with one embodiment of the invention.

FIG. 10 is a simplified schematic diagram of a component communication configuration in accordance with one embodiment of the invention.

FIG. 11 is a simplified schematic diagram illustrating an exemplary interface for a settings component in accordance with one embodiment of the invention.

FIG. 12 is a simplified schematic diagram illustrating a component messaging system in accordance with one embodiment of the invention.

### DETAILED DESCRIPTION

An invention is described for an apparatus and method for a document exchange session for an ad-hoc conference session. It will be apparent, however, to one skilled in the art, in light of this disclosure, that the present invention may be practiced without some or all of these specific details. In other instances, well known process operations have not been described in detail in order not to unnecessarily obscure the present invention.

The embodiments of the present invention provide a device and a framework for the real-time exchange of hard-copy documents during a conference. The framework supports multi-party document transfers and is designed to compliment communication exchange on existing tools, i.e. telephones, audio and video conferencing solutions, etc. The device has a simple-to-use document transfer interface, so the participants are not distracted from the real-time exchange. A fast data network is available for “real-time” transfers, however a computer system is not required. The device may coexist in the world of existing communication and conferencing solutions, such as, telephone conferencing, videoconferencing, WebEx meetings, etc. As explained in more detail below, the device is securely managed such that only participants in the exchange have access to the hard-copy documents.

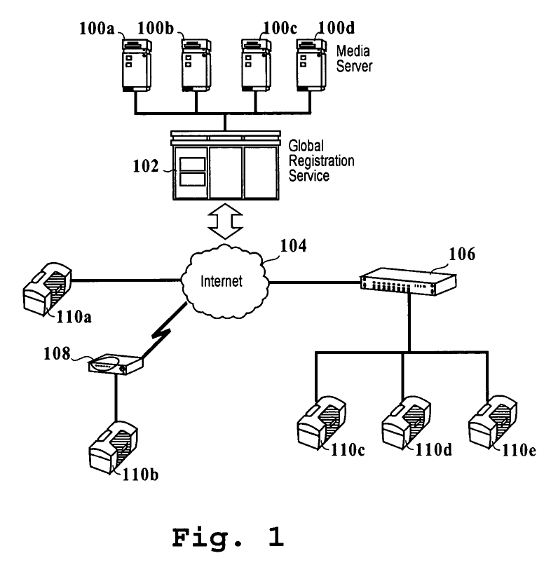

FIG. 1 is a simplified schematic diagram of a system in which document exchange devices are interconnected in order to exchange documents in an add-hoc manner during a real-time conference in accordance with one embodiment of the invention. The system includes a meeting media server, which may be more than one such server, as illustrated by meeting media servers 100a through 100d in FIG. 1. Global registration service 102 is connected to each of media servers 100a through 100d. Document exchange devices 110a through 110e communicate through a distributed network 104 to global registration service 102. As illustrated in FIG. 1, the document exchange devices may be connected directly or indirectly to a distributed network, such as Internet 104, in different ways. For example, document exchange device 110b is connected to distributed network 104 through DSL modem 108. Document exchange devices 110c through 110e each communicate with distributed network 104 through router 106. Alternatively, the document exchange devices may be connected directly to distributed network 104 as is document exchange device 110a. In one embodiment, distributed network 104 is the Internet.

Still referring to FIG. 1, global registration service 102 functions as a registration service center that accepts device registration and meeting configuration information. Global registration service 102 is available to all devices through a high bandwidth connection on the data network. Global registration service 102 comprises a meeting dispatcher service component and a meeting load-balancer component in one embodiment. The meeting dispatcher service component handles ad hoc meeting creation, setup, and teardown. The meeting load-balancer identifies and allocates space on meeting media servers 100a-100d for a meeting. Meeting media servers 100a-d interconnect with document exchange devices 110a-e in the context of a document exchange session. Meeting media servers 100a-d host the document exchange session, and the overall function of the server(s) is/are central to all document exchange activities. Documents copied through device operations will be temporarily stored on the server(s) and transferred among and routed to all other interconnected devices. Meeting media servers 100a-d act like a conferencing system's multi-point control unit (MCU), but for electronic representations of hard-copy documents.

Continuing with FIG. 1, the data network connection port of each of the document exchange devices provides a communication link to enable interconnecting each device through a data network. The data network may be defined to support any common networking transport and protocols, e.g., Ethernet, 802.11 a/b/g, TCP/IP, etc. All devices that are interconnected have access to the data network. The data network enables connection to the global registration service (i.e. across the Internet, for example). In one embodiment, techniques may be employed to traverse firewalls, routers, and other devices across this data network. One such technique is further explained in co-owned application Ser. Nos. 10/681,523 and 10/935,980, each of which is incorporated by reference herein. Document exchange devices 110a-e are the primary components used by respective participants who wish to send or receive hard-copy documents in a conference. Each document exchange device in the group 100a-e is functionally the same; each such device may be, and preferably is, configured in the same way. Hence, for ease of discussion, one such device, identified by reference numeral 110, will be used in describing such functionality, as well as the additional components that each document exchange device contains, or with which each such device is associated.

Document exchange device 110 comprises a scanner/capture component, a printer/output component, a user-interface panel component, and a data network connection component. Document exchange device 110 may have optional components for offline functionality, such as for use as a standalone copy machine, a personal computer printer, a network printer, a fax machine, or other document related tools. In one embodiment, the scanner/capture component will accept documents, drawings, photos, annotations, or the like.

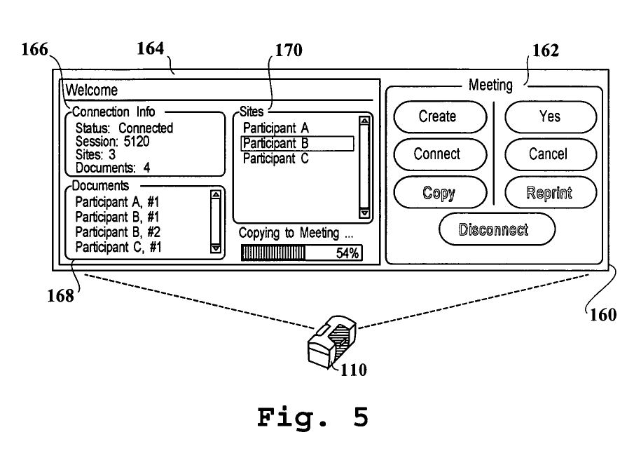

Document exchange device 110 allows for interconnection with other document exchange devices before, during, after, or in parallel to a conference communication. It should be appreciated that real-time multi-party hard-copy document transfer/exchange takes place through the data network, while audio/video communication takes place through the phone network or other conferencing channel in one embodiment. The panel of document exchange device 110 provides simple functions to easily create an ad hoc logical meeting for the interconnection of desired devices as illustrated with reference to FIGS. 5 and 6. A simple copy operation is available to immediately provide hard-copy results to attending participants. The user can place documents into his/her document exchange device 110, and a copy of those documents will be transmitted to and printed by the other connected document exchange devices interconnected by a logical meeting across the data network. Late joiners to the meeting can use a reprint operation to obtain documents previously exchanged. In one embodiment, the participant hosting the document exchange session enforces authentication of participants. It should be appreciated that any number of meeting media servers and document exchange devices may be in communication through the distributed network. That is, the number of components represented in FIG. 1 is not meant to be limiting as any suitable number of servers and exchange devices may be utilized in the system.

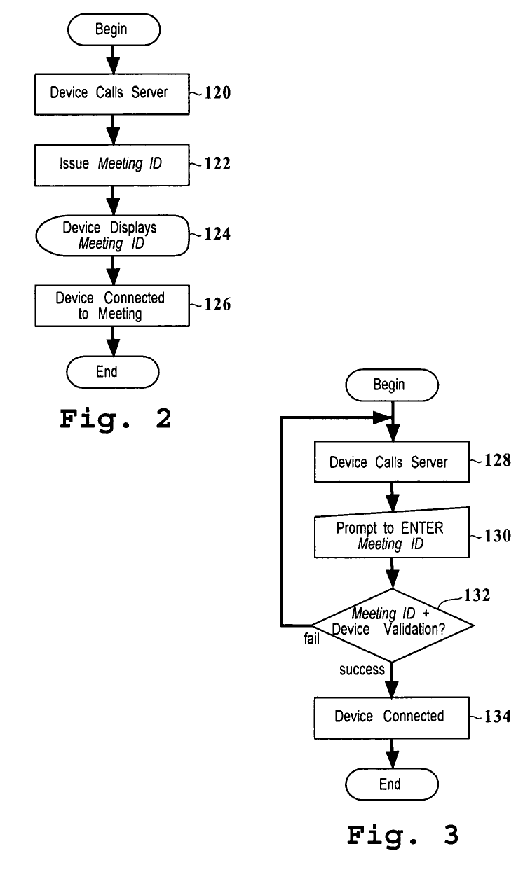

FIG. 2 is a flow chart diagram illustrating the method operations for creating a meeting through a document exchange device in accordance with one embodiment of the invention. The method initiates with operation 120 where a document exchange device calls the server, e.g., the meeting media server, through the global registration service and the distributed network as illustrated with reference to FIG. 1. For example, a first participant may press a create meeting button on the interface of the document exchange device he is using (see FIGS. 5 and 6) to initiate a connection and meeting/session creation. The global registration service will issue a unique meeting identification number in operation 122. The meeting identification number is then displayed on a display portion of the interface of the document exchange device creating the meeting in operation 124. Exemplary interfaces of the document exchange device are discussed with reference to FIGS. 5 and 6. Thereafter, the document exchange device is connected to the just-created meeting in operation 126. Here, the document exchange device can be assigned to one of the meeting media servers, which will act to host the document exchange session. In one embodiment, the global registration service will consider activity of each of the meeting media servers when assigning the document exchange device to a meeting media server, in order to provide for load balancing. That is, the document exchange device may be assigned to a meeting media server having the least amount of activity.

Creation of logical meetings among select devices is handled by request of a device's user and through the global registration service. A meeting media server is assigned to manage the meeting, provide temporary storage for meeting documents, notify document exchange devices of the arrival of new documents, and actively transfer documents among the document exchange devices for hard-copy output. The meeting media servers communicate with the global registration service for meeting status and participant registration information.

Each document exchange device is assigned a device-unique registration identification number, which is stored by that device for identification. This registration identification number may be assigned to the device at its creation, or may be assigned to the device when it first connects with the global registration service. Similar to a Media Access Control (MAC) address, the registration identification number is guaranteed to be unique among all document exchange devices. A user-defined site name may be associated with this registration identification number. This site name is stored with the document exchange device and in the global registration service. The user-defined site name is optionally used to display and identify a document exchange device that is interconnected in a meeting. The initial registration process automates the setup of the document exchange device and ensures that the global registration service has a mapping between registration identification number and optional site name.

FIG. 3 is a flow chart diagram illustrating the method operations for additional participants to connect to a document exchange session once the session has been created, in accordance with one embodiment of the invention. The method of FIG. 3 occurs after the meeting is created. The method of FIG. 3 initiates with operation 128 where a remote participant connects to the document exchange session by calling the meeting media server through the document exchange device. For example, a remote participant may press a connect button on the document exchange device interface (see FIGS. 5 and 6). In response to activating this button, the document exchange device accesses the data network through a data connection port and locates the global registration service. The method then advances to operation 130 where a prompt to enter the meeting identification number is issued. The meeting identification number may be initially communicated to the user through an alternate communication line, e.g., a telephone. For example, two or more parties may be having a telephone conversation and realizing that documents need to be exchanged, a meeting can be created as discussed above with reference to FIG. 2 by a first party, and then the second party may connect to the meeting as discussed herein with reference to FIG. 3. Once the meeting is created the first party can communicate the meeting identification number over the phone to the second party. The second party will enter the meeting identification number, and once the identification number is validated, in operation 132, the device will be connected to the document exchange session in operation 134. If the meeting identification validation fails, the method will return to operation 128 and proceed as discussed above. It should be appreciated that device validation initially ensures that an incoming device's registration identification number is valid in the system. Then, the meeting identification number is validated as an active meeting. In one embodiment, the optional site name or registration device number is presented to the first (hosting/meeting creator) participant on the document exchange device interface. This hosting participant must accept the joining device into the meeting, e.g., by pressing a Yes button the hosting participant's interface, to allow the participant to join. Then the joining device is fully validated and added to the meeting. If the hosting participant does not accept (e.g., the hosting participant presses Cancel or waits for some timeout period), the document exchange device attempting to join the meeting is not validated and is not permitted to join the meeting. In one embodiment, a time-out may be incorporated limiting when the document exchange device that failed the validation can attempt to re-connect to the document exchange session. Security for the document exchange can be provided using encryption techniques across the data network. These may include device interconnection techniques like Secure Sockets Layer (SSL), or data stream encryption like Data Encryption Standard (DES).

In addition to being configured to digitize hard-copy documents via its scanner and transmit the corresponding electronic documents, a document exchange device may also be configured to directly accept electronic documents for transfer to the other interconnected document exchange devices for remote printing. For example, a slide presentation, camera photos, application documents, etc. may be delivered to a document exchange device via a personal computer connected on the network, as an email, or as a hardware option (i.e. memory card, USB flash drive, etc.), or other form.

In yet another embodiment, audio and/or video communication capabilities may be added to the device. In this case, all communication would flow through the data network. In this embodiment, the document exchange devices are interconnected by the global registration service and managed via a meeting media server acting as an audio/video/document conferencing MCU. Real-time communication and hard-copy document exchange can be realized through a single device. One exemplary MCU that may be incorporated into this embodiment is the MCU of application Ser. No. 10/440,526, which has been incorporated by reference.

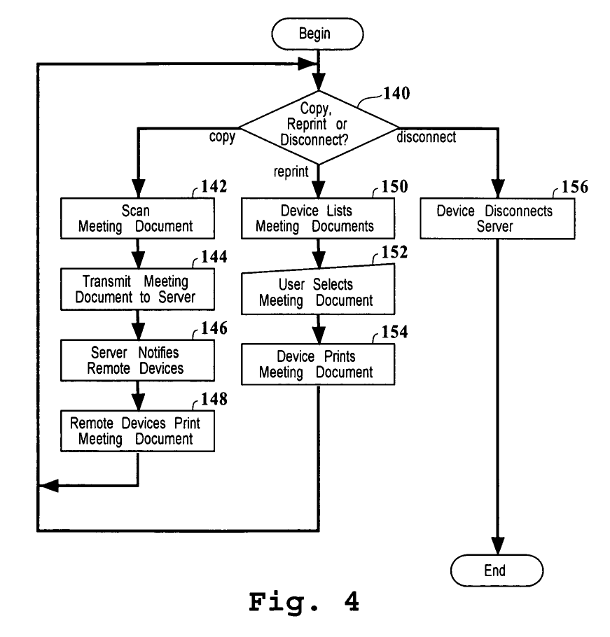

FIG. 4 is a flow chart diagram illustrating the method operations in which a document exchange device may copy, reprint, or disconnect from a meeting in accordance with one embodiment of the invention. It should be appreciated that the method operations of FIG. 4 are enabled after a meeting has been created and another participant has joined the meeting. The method initiates with decision operation 140 where it is determined whether to copy, reprint or disconnect from a document exchange session. Here, a participant pressing a device operation button that signals the appropriate function may accomplish this feature. If a document is to be copied to the document exchange session, the method proceeds to operation 142 where the meeting document is scanned through the document exchange device. Then, in operation 144, the meeting document is transmitted to the meeting media server. Upon receipt of the document by the meeting media server, the meeting media server will notify the remaining remote document exchange devices in operation 146. In one embodiment, a user interface of the document exchange device indicates the document is available. Once the remote devices have been notified that the document is available, the document exchange devices may print the meeting document in operation 148. The method then returns to decision operation 140.

If, in decision operation 140 of FIG. 4, it is decided to reprint a document, then the method advances to operation 150. In operation 150, the document exchange device lists the available meeting documents for reprinting. As will be explained in more detail with reference to FIGS. 5 and 6, a user interface may be used to display a list of the meeting documents. The method then advances to operation 152 where a selection of a meeting document is made. Here, a user may select a meeting document from the list on the display interface of the document exchange device. The method then moves to operation 154 where the meeting document is printed by the document exchange device. The method then returns to decision operation 140. Continuing with decision operation 140, if it is decided to disconnect from the document exchange session, then the method advances to operation 156 where the document exchange device is disconnected from the server, which in turn disconnects the document exchange device from the document exchange session.

FIG. 5 is a simplified schematic diagram of an exemplary user interface, which is displayed on a document exchange device in accordance with one embodiment of the invention. User interface 160 includes connection information region 164 and meeting control region 162. As illustrated in FIG. 5, user interface 160 is displayed on a document exchange device, such as document exchange device 110. Connection information region 164 includes connection information sub-region 166, document region 168 and a list of participants in region 170. As shown, sub-region 166 includes information on the status of the connection, the session identification number, which represents a unique identification number related to the meeting identification number and the active document exchange session, the number of sites connected to the document exchange session, and the number of documents available. A list containing a reference to each of the documents available appears in region 168. Here, participant A has contributed one document, participant B has contributed two documents, and participant C has contributed one document. Region 170 includes a list of participants connected to the meeting. The site name mentioned above, for a document exchange device may be displayed in region 170. Also included in region 164 is a status bar indicating the status of transmitting a document to the document exchange session, i.e., the meeting media server, or receiving a document from the meeting media server for (re)printing. The status bar could also be used to identify progress of other activities on the document exchange device. Meeting control region 162 includes buttons that enable the participant to copy, reprint, and exchange documents through the document exchange session. In addition, buttons are available to allow a participant to create a meeting and control access to the document exchange session. It should be appreciated that user interface 160 is a touch screen in one embodiment of the invention and the buttons referred to herein are not depressible buttons.

As discussed above, some of the information displayed on the user interface with the document exchange device includes: the device connection status, the meeting identification number or session identification number, the number of other document exchange devices (Sites) in the meeting, the count of documents exchanged, a list of all sites connected, a list of all documents exchanged, and a progress meter indicating current document transfer status. Quick use buttons within the control regions are provided on the user interface to create or connect to a meeting, copy or reprint documents, disconnect from the meeting, or approve/cancel operations, such as authentication/validation of an incoming document exchange device into the meeting as described above.

FIG. 6 is an alternative user interface, which may be incorporated onto a document exchange device in accordance with one embodiment of the invention. Here, document exchange device 180, which may be a copier, includes user interface 160. User interface 160 includes connection information region 164 and meeting control region 162. Connection information region 164 includes connection information sub-region 166, document information region 168 and a list of participants in region 170. In addition, user interface 160 includes a video display region 172 within connection information region 164. It should be appreciated that audio and/or video communication capabilities may be added to document exchange device 180. Thus, document exchange device 180 can be utilized to act as a client for a videoconference session. In order to accommodate audio capabilities, interface 160 of document exchange device 180 is shown having microphone 174 and the document exchange device includes speaker 176. It should be appreciated that document exchange devices, such as document exchange device 180, would be interconnected by the global registration service and managed via a meeting media server acting as an audio/video/document conferencing multi-point control unit as mentioned above. Thus, real time communication and hard copy document exchange can be realized through a single device, i.e., document exchange device 180. In this embodiment, data will be communicated through the common data connection port of document exchange device. That is, all video/audio and document exchange data will be communicated through a common communication path.

It is should be appreciated that the user-interface of a videoconferencing application be configured to remove as many unnecessary complexities as possible so that the user can focus on the conference information being provided and not on application interface management duties. Window management is one such area of complexity. For example, suppose a user-interface for a videoconference application consisted of several independent windows, such as the interface of FIG. 6, one for each displayable media in the presentation (i.e. a video window, a document window, a log window, etc.). Each window would require separate placement by the user. Poor placement could result in inefficient gaps between windows, window overlapping, or window clipping. Overlapping and clipping causes content to be obscured and missed. The embodiments discussed below are applicable to the screen described with reference to FIG. 6 or the traditionally sized display interfaces for videoconference applications.

Videoconference systems thus employ various alternatives for window management methods. Some provide fixed regions for each interface and media element. Others provide scalable non-overlapping regions. However, it is important for a system to provide the user flexibility to change the interface according to dynamic videoconference content, while preserving an efficient window layout. This flexibility should not increase the window management burden for the user.

A configurable layout system is described below that automatically adjusts to prevent the appearance of gaps and overlaps using non-overlapping resizable windows. The system automates the configuration process to preserve layout while giving the user simple and powerful reconfiguration tools for swapping window locations and sizes. Content of interest can be quickly scaled and brought to a primary position of focus in the interface with a simple operation. In one embodiment, the remote speaker in a videoconference can select a content of interest, e.g., a PowerPoint slide being discussed, and instruct the other conference clients to position the content in the primary location or their respective interfaces.

Since a videoconference application may be used in a meeting/conference room, i.e. projected onto a wall or on a TV, a full-screen mode is also defined in one embodiment for this application interface. Several different requirements are necessary for this mode as navigation and configuration of UI elements should be available, but hidden by default, to maximize the utilization of the output display. A picture-in-picture element is used to show alternate/supporting conference content. The design of the cell and component management system described herein is flexible enough to support the different requirements of full-screen and desktop modes.

As mentioned above, in addition to the duality of full-screen and desktop modes for a PC computer application, the system described herein supports other application environments like PDA devices, print servers, or of the like. Individual requirements of each environment dictate which modules are used. For instance, a printer device may require document access but no video communication. A PDA device or the device of FIG. 6 may have a limiting layout. Another configuration might define a thin client not having access to document-sharing capabilities. To accommodate the variety of such configurations, a modular design is used, allowing for easy addition and removal of code modules by reducing module dependencies.

The cell and component management system described herein is designed to display multiple windows containing relevant information in a non-overlapping manner. The system's goal is to organize, simplify and otherwise automate management of these visual elements while maximizing the amount of information presented. Efficient user interface elements and functions are provided for selection of the interesting content and interface configuration without complex window management. An underlying component management system employs a modular design that allows reconfiguration of the application features by simple adding or removing of component parts. A messaging system between components establishes firm rules of communication while allowing for further modularization, even across multiple machines.

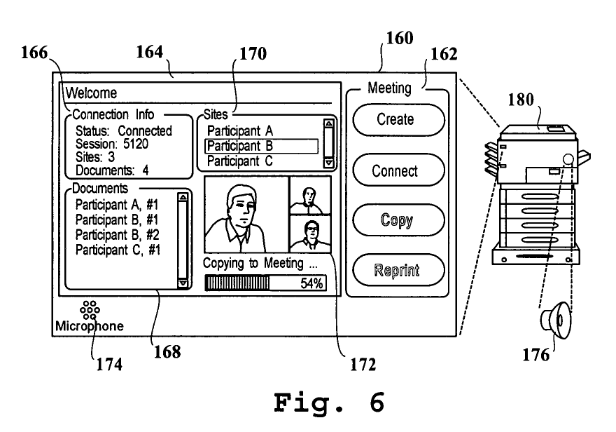

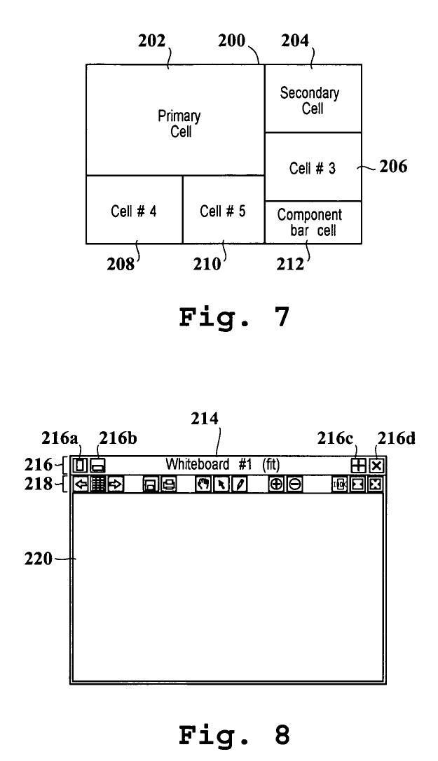

FIG. 7 is a simplified schematic diagram of an exemplary application layout in accordance with one embodiment of the invention. Layout 200 subdivides the rectangular area belonging to the application window. Each region in layout 200 is referred to as a cell. One cell is assigned to be component bar cell 212 while all other cells, e.g., cells 202, 204, 206, 208, and 210, are called component container cells. Among the component container cells, one is designated as primary cell 202 and another as secondary component container cell 204.

Primary cell 202 of layout 200 is identified as the key focal point for the application. Primary cell 202 is where the user signals the placement of the most important content (or the content of visual interest) at any given time. Generally, primary cell 202 is the largest region in the layout. An application may allow the user to choose from a list of predefined layouts. Alternatively, a set of user tools may be provided to allow dynamic configuration of a layout. Such tools may allow options such as “split horizontally,” “split vertically,” “delete cell,” “set cell as primary,” “set cell as secondary,” “set cell as component bar” and “reset layout.”

In one embodiment, the sub-divisions between cells are kept in percentage points. Therefore, when the application area is resized as a whole, the relative size of the cells will remain the same. Similarly, when a sub-divider is moved, it may shift other sub-dividers of the same orientation to preserve the proportions of the subsets.

FIG. 8 is a simplified schematic diagram illustrating a component container cell designed to contain a component in accordance with one embodiment of the invention. Component container cell 214 is made up of three parts: title bar 216, toolbar 218, and component area 220. The main function of title bar 216 is to display the title of the contained component and to show container control and management buttons. These buttons include:
Component container menu button 216a, which brings up the component container menu. This menu allows selection of available visual components, global application functions, or specific contained component operations.
Toolbar show/hide button 216b, which hides or shows the component's toolbar.
Component grow button 216c, which grows the component.
Close component button 216d, which empties the component container by placing the contained component onto the component bar.

If a component container is empty, only menu button 216a is available. Component grow button 216c provides a significant configuration tool for the user. When grow button 216c is activated, the cell content associated with title bar 216 is swapped with the content of the primary cell. If the grow button of the primary cell's title bar is pressed, full-screen application mode is activated and the primary cell's content fills the display.

The unique grow function has an optional mode available to an identified speaker in the videoconference. For example, during a videoconference the speaker may be interested in explaining a diagram displayed in his document component and wants to be certain all clients are aware of the diagram content. By right-clicking on grow button 216c, a signal sent between all clients of the conference, e.g., via a server backchannel or an alternate client directed interface, instructs all other client applications to position the selected component to the primary cell. The speaker can thus request that the document component be grown to place it in the primary cell of the remote clients. Since the primary component container cell is typically the one of largest area, the component with interesting content will be prominent in the interface. The effect is as if the speaker pressed the appropriate component grow button on each of the remote clients interfaces.

Component container menu button 216a provides another configuration tool for the user. When activated, a list of available visual components is provided (in addition to application and component specific options). When a component item is selected, the cell content associated with the title bar is swapped with the menu-selected component. The secondary function of title bar 216 is to provide an area to initiate a component drag-and-drop operation.

Toolbar 218 displays a set of controls (buttons, sliders, tabs etc.) defined by the contained component. Each component defines its set of toolbar controls, along with associated bitmaps. Each component also provides interfaces for enabling/disabling and updating control values, and processing toolbar events such as button clicks or slider updates.

Component area 220 is a resizable rectangular area inside the container where visual elements of a component are displayed. Since the heights of title bar 216 and toolbar 218 are fixed, the component area's size changes to fill out the unused portion of component container 214.

A component bar is a special type of a container that can display multiple components in button form. The set of components displayed in the component bar consists of any visual component that is not displayed in a visible container, as well any available action component. When an action component button is clicked, the associated component is notified to perform its designed action. When a visual component button is clicked, the associated component is presented in an available empty component container. If all the component containers are occupied, the container with the least priority is filled with the component, while the replaced one is placed in the component bar. In some cases, the application may define a single floating cell for this particular purpose that will stay hidden when empty.

In one embodiment, two kinds of drag-and-drop operations are supported: container drag-and-drop and component button drag-and-drop. Container drag-and-drop is initiated by clicking on the title bar of an occupied component container cell and dragging the container, which results in dragging of the entire container. When the button is released, the system calculates where the component was dropped by looking up one or more of several possible factors, such as, location of the mouse, location of the dropped container relative to all the cells (intersect area as a percentage of the container area), or location of the cells relative to the dropped container (intersect area as a percentage of the belonging cell's area). Depending on the result one of three actions are taken:
Component swap—result of dropping a container over another that contains a component.
Component move—result of dropping the container over another that does not contain a component.
Component close—result of dropping the container onto the component bar.

If the component is dropped onto its old location or over an invalid area (i.e. outside the application window), the component snaps back to its original place. Component button drag and drop is initiated by clicking and dragging a visual component button from the component bar (drag-and-drop of an action component button is not available). When the button is dropped, the target is determined and the actions taken are:
Component open—result of dropping the button over an empty container, the component is opened in that container.
Component swap—result of dropping the button over an occupied container, the dragged component is opened in that window while the old one is removed and placed on the component bar.
   If the button is dropped into the component bar or in an invalid area, the button snaps back to its original location.

FIG. 9 is a simplified schematic diagram illustrating the configuration of the components of an interface, in accordance with one embodiment of the invention. In full-screen mode, primary cell component 222 is displayed over the entire screen. Secondary cell component 224 is scaled and optionally shown overlapping primary cell 220 (mimicking a picture-in-picture effect). The title bar for each is hidden, as are toolbars 222a and 224a (except in cases where component style specifies that the toolbar cannot be hidden). When the mouse is placed at the top of the screen, toolbar 222a reveals itself over the component. Additionally, when the mouse reaches the bottom of the screen, component bar 226 reveals itself over the component. Component bar 226 in this mode may be expanded with additional buttons such as “Switch Picture-in-Picture”, “Leave Full-Screen Mode” or “Exit Application”. Similarly, the secondary cell's title bar and toolbar are hidden from view unless the mouse is over the cell. As such, secondary cell 224 can be freely moved and resized by the user.

The same rules apply to the navigation in full-screen mode as do in desktop mode. Namely, clicking on the component grow button in the secondary cell will swap it with the primary cell, and clicking on a component bar button will place the associated component inside the secondary cell. Drag-and-drop operations for component bar buttons also apply; however, drag-and-drop operations for the secondary cell are disabled since it makes more sense for the cell to act as a normal window.

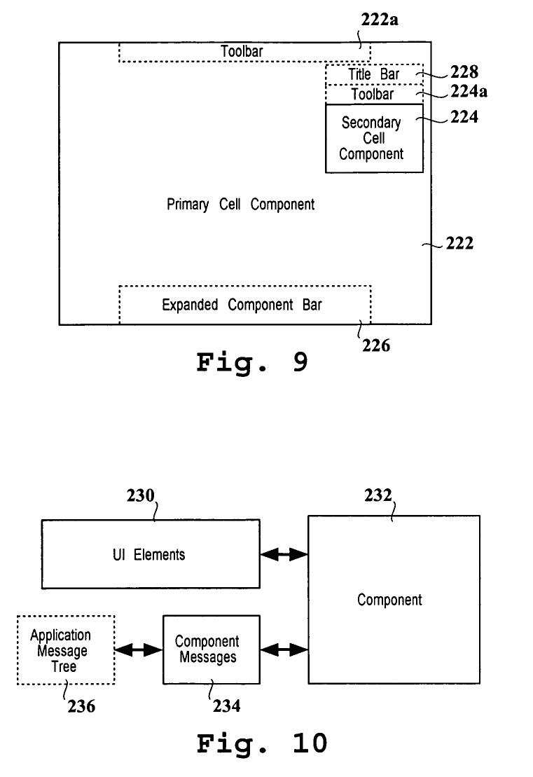

FIG. 10 is a simplified schematic diagram of a component communication configuration in accordance with one embodiment of the invention. Each component is designed to function independently. User interface (UI) elements (buttons etc.), either in the component's UI, toolbar, or the associated component bar button, can be used to trigger operations performed by the component. Alternatively, component 232 may send out or respond to messages from other components through component message module 234 and application message tree 236. Component sets can be defined at design time, or they can be available as extensions or plug-ins in run-time. This allows components to be developed and updated independently as long as commonly defined parameters (such as messages) do not change. In one embodiment, the component interface provides a method to report its name and bitmap representation for the component bar (or none for a hidden component).

In another embodiment, there are four basic types of components. A visual component is the most common component type and maintains a resizable user interface that can be shown to the user in a component container cell. Most frequently, these components also maintain a list of toolbar controls that are presented by the container. A visual component usually sends out and responds to component messages (if functionally required).

An action component is a component with no visual interface. It cannot be displayed in a component container. The only user interface an action component supports is an assigned button in the component bar. Clicking on this button triggers a single component action, therefore, the action component is usually defined by the action it performs. Optionally, an action component may also transmit and respond to component messages.

A component that has no visual interface and no user action associated with it is called a hidden component. These components cannot be displayed in either a component container or on the component bar. The functionality of these components can only be triggered through component messages.

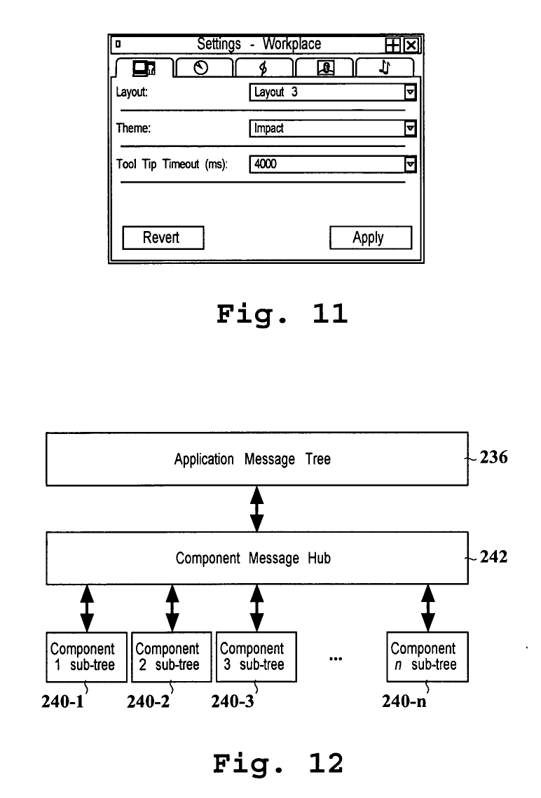

For the purpose of presenting advanced configuration options for each component that may require it, a special kind of a visual component called a settings component may be provided. Through component messaging or other similarly designed interface, a component can communicate what options to make available and through what interface, i.e., check boxes, radio buttons, sliders etc. The settings component then presents these options in an organized manner, such as using a tab or similar interface, and notifies the referring component when options are changed. FIG. 11 is a simplified schematic diagram illustrating an exemplary interface for a settings component in accordance with one embodiment of the invention. Some exemplary videoconference components include the following:
Real-time Video/Audio Component
Document Display Component (PowerPoint slides, whiteboards, etc.)
Messaging Component (Chat)
Participant Log Component (System connection status)
Settings Component (interface configuration)

FIG. 12 is a simplified schematic diagram illustrating a component messaging system in accordance with one embodiment of the invention. Component messages provide a means of communicating among components. Since the components cannot assume the presence of other components, each component message satisfies the three following requirements in one embodiment:
Component message id is unique.
Component message id is published to ensure any later-defined component message does not choose the same id.
Component message parameters are well defined and known to all components that may transmit or receive that component message.

Each component maintains a message tree with a well-defined root 240-1 through 240-n, which is usually the component object itself The root of the message tree is then attached to application message tree 236 via a component message hub 242. Being linked through a message tree allows messages to be exchanged between components or between a component and the application. In one embodiment, there may be four kinds of messages based on the chosen domain, which are listed below:
Local message—distributed throughout the message tree until it is processed by a component that understands it (even if the result is negative).
Broadcast message—distributed throughout the message tree regardless of result. The return value is the most positive of returned results (positive supercedes negative, negative supercedes not supported).
Directional message—distributed in a chosen direction until it is processed or there are no more candidates. An up-direction message gets processed by the component message hub or its parent objects. A down-direction message will get processed by the child objects. This allows for internal component messages that never leave the component.
Targeted message—a message that is not distributed using the usual means, but is only intended for—a specific object. This kind of message is usually used when sending the message to the parent object, a known child object, or in some cases to itself.

In one exemplary application, a file browser component lets a user select an image file and then click an “Open” button. This component, however, does not support viewing image files. Instead, the component will send out a well-defined global message that contains all the necessary information for opening the selected file, e.g., a file path. The message will crawl through the message tree until it is processed by a component that knows how to process the message. Once the image file is opened for viewing, the original sender is notified of the positive result and knows that the “Open” action was completed. Alternatively, if there are no components in the tree that can process the message, the sender is notified of that and may display a “No viewing interface present” prompt to the user or handle the error in another way.

Expanding on the above example, the viewer component spends a significant amount of time decoding each file being viewed. An optional component of the system may be an image cache. Before the viewer component decodes an image file, it will send out a message requesting a cached image data. Depending on the response, the viewer can deduce if the image cache component is available, and if the image has been cached. This allows the viewer to proceed in one of three directions:
Image cache is available, image data is cached—allows the viewer to skip the decoding process.
Image cache is available, image data not cached—the viewer will decode the image file and send the decoded information to the image cache component for future reference.
Image cache is not available—the viewer decodes and shows the image file with no further communication attempts.

Note that in the last case, the decision for no further communication attempts is optional, and that in some scenarios the image cache may become available at a later time —in which case the viewer component should continue attempting communication before and after each decode. Failed communication attempts will simply be ignored. It should be appreciated that that caching component is a good example of a hidden component.

In summary, the above-described invention provides for convenient document exchange during an ad hoc meeting. For example, a multi-party call may be established using the appropriate phone network operations. During the call, one participant decides that documents need to be exchanged, and initiates the creation of a document exchange session by activating the Create Meeting button on his document exchange device. The device accesses the data network, locates the global registration service, and begins communication with the service component. The global registration service issues a unique meeting identification number (ID) for the exchange, performs some local load-balancing and meeting dispatching, and connects the participant's document exchange device to a newly created logical meeting hosted on an assigned meeting media server. The meeting ID is displayed on the participant's document exchange device and the device is connected to a meeting media server. Using the telephone network, the participant verbally notifies other members of the newly created meeting ID so that they can connect their document exchange devices to the ad hoc meeting.

Each remote participant simply presses the Connect to Meeting button on their document exchange device. In turn, the device accesses the data network and locates the global registration service. Each remote participant is then prompted by his device to enter a meeting ID on the device panel. Once the meeting ID is entered (and validated) the remote participant's devices are connected with the meeting media server hosting the meeting documents. As each device is connected to the meeting, the document exchange device panel will show a count of connected devices along with each device's unique registration ID (or site name, if so provided).

Once connected to a meeting, any participant can place a document on their document exchange device's scanner and use the Copy to Meeting function. This operation will scan the document using the devices scanner/capture component and transmit it to the meeting media server over the data network. The meeting media server notifies all other connected document exchange devices in the meeting that new documents have arrived. The new documents are stored in a temporary location on the meeting media server. Documents are named with the registration ID (or site name) and a count reflecting the number of the document received from the document source device. When a document exchange device receives notification of a new document's arrival, it displays the document name and immediately makes a request to retrieve the document from the meeting media server and starts printing the document as it is received. Documents held in the meeting media server remain until the meeting is terminated.

If a participant joins a meeting after some documents have been exchanged, or if a participant wants another copy of a previously copied document, the participant can consult the document list on his document exchange device's panel. By selecting a document from the list and using the Reprint Meeting Document function, the document exchange device can request a transfer of the document from the meeting media server and reprint the document as it is received.

When a participant wishes to leave a meeting, the Disconnect from Meeting button is chosen. This notifies the meeting media server that the device is leaving. All other connected devices are updated with the departure information. If the participant who created the meeting leaves, all other devices are disconnected from the meeting media server and the meeting is closed.

When enabled, the authentication process to join a meeting allows more security for private exchanges. When a remote participant attempts to connect to a meeting, the document exchange device of the participant who created the meeting is notified. That participant may allow or deny the connection. When prompted on the display panel of the device, the hosting participant presses YES to allow the remote participant access to the meeting. Pressing Cancel will not allow the participant to access the meeting and not pressing Yes or Cancel within a required timeout interval will automatically not allow the participant to access the meeting (as if Cancel was pressed). In one embodiment, that participant will not be allowed to access another meeting for a system-determined period of time if the participant is denied access. This controls abuse of the authentication process.

Additionally, a cell and component messaging system is discussed for the management of user interface features. A method and system for managing components through a component messaging system is provided. Each component includes a message tree having a root attached to a global application message tree through a component message hub. This architecture allows a message to be exchanged between components or between a component and an application. Thus, through this architecture, it may be possible for a component without a certain feature to locate another component that may provide the needed feature. For example, if a certain component does not support functionality for opening image files, a message sent through the component message system can locate a component that can open image files. This component opens the file and then returns a message to the component not capable of opening the file that the action was completed.

While the discussed cell and component embodiments were directed toward use with a videoconference application, the architecture described by these embodiments also allows for flexibility in development and debugging. That is, components can be developed and updated independently since removal or addition of the component can be done with relative ease through the architecture defined above. For example, where one component is a log component that is configured to display messages, a developer may use the architecture described above to log or display messages during debugging of various components. This log component can then be removed after completion of debugging. The removal of the log component has no impact on the system performance as the system is designed such that failure to find the log component will simply result in the logging not being performed and will not have any other impact on performance.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as a set of instructions, e.g., code contained on a device-readable (e.g., a computer-readable) medium or waveform. The medium may be any data storage device that can store data that can be thereafter read by a computer system. Examples of the device-readable medium include hard drives, network attached storage (NAS), read-only memory, random-access memory, CD-ROMs, CD-Rs, CD-RWs, magnetic tapes, and other optical and non-optical data storage devices. The medium can also be distributed over a network coupled computer system so that the code is stored and executed in a distributed fashion. The waveform includes an electromagnetic carrier wave in which the code is embodied.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A system providing a document exchange session for a conferencing session, comprising:
a plurality of document exchange devices;
a meeting media server configured to store document data from any of the plurality of document exchange devices and transfer document data among the plurality of document exchange devices; and
a registration service device in communication with each of the plurality of document exchange devices, the registration service device configured to process requests from the plurality of document exchange devices to identify the corresponding document exchange session, the registration service device including,
a meeting dispatcher service component configured to handle document exchange session creation; and
a meeting load balancer component configured to allocate space on the meeting media server for the document exchange session according to meeting media server activity.

2. The system of claim 1, wherein each of the plurality of document exchange devices includes a capture component and an output component.

3. The system of claim 2, wherein each capture component is a scanner and each output component is a printer.

4. The system of claim 1, wherein each of the plurality of document exchange devices is assigned a unique identification number.

5. The system of claim 4, wherein the registration service uses the unique identification number to authorize access to the document exchange session.

6. The system of claim 2, wherein the registration service assigns a meeting identification number to a document exchange device establishing the document exchange session, the meeting identification number being utilized by the remaining document exchange devices to join the document exchange session through a different communication path than conference session data.

7. The system of claim 1, wherein each of the plurality of document exchange devices includes a user interface that displays document exchange session connection information, a list of available documents from the meeting media server, and a list of connected document exchange devices.

8. The system of claim 7, wherein each user interface enables notification to a document exchange device establishing the document exchange session that the document exchange device associated with that user interface is attempting to join the document exchange session.

9. The system of claim 8, wherein the user interface of the document exchange device establishing the document exchange session enables a user to prevent another document exchange device from joining the document exchange session.

10. A document exchange device for assistance with an audio/video conferencing session, comprising:
an image capture component configured to generate a scanned image of a document to be transmitted;
an output component configured to provide a printed image of a received document;
a user interface configured to display connection information, the connection information including whether the device is connected to a document exchange session associated with the conferencing session, a list of documents exchanged during the document exchange session, and a list of other document exchange devices connected to the document exchange session; and
a data network connection port.

11. The device of claim 10, wherein the user interface includes a control region, the control region enabling a user to authorize participation in the document exchange session.

12. The device of claim 10, wherein the user interface enables a user to request an electronic version of a document from a remote storage device.

13. The device of claim 10, wherein the document exchange session occurs through the data connection network port and the conferencing session occurs over a different connection.

14. The device of claim 10, wherein the user interface includes a display screen for displaying information identifying participants of the audio/video conferencing session, and a microphone and a speaker enabling audio communication between the participants.

15. The system of claim 14, wherein audio/video data and the document exchange data flow through the data network connection port.

16. A method for exchanging documents during a conference session, comprising method operations of:
identifying a document to be exchanged between participants of the conference session;
creating a document exchange session through a document exchange device of one of the conference session participants;
scanning the document through the document exchange device;
simultaneously notifying all other document exchange devices of other conference session participants that the document is available; and
retrieving the document through each of the other document exchange devices in response to receiving notification that the document is available.

17. The method of claim 16, wherein the method operation of scanning the document through the document exchange device includes,
temporarily storing the scanned document at a server unrelated to conference session data.

18. The method of claim 16, wherein the method operation of creating a document exchange session through a document exchange device of one of the conference session participants includes,
validating a joining document exchange device through a unique identification number assigned to the joining document exchange device.

19. The method of claim 16, wherein the method operation of creating a document exchange session through a document exchange device of one of the conference session participants includes,
creating a document exchange meeting identification number;
communicating the document exchange meeting identification number to conference session participants through a communication path separate from a document exchange meeting communication path; and
entering the document exchange meeting identification number through the document exchange device to join the meeting.

20. A medium or waveform containing a device-readable set of instructions adapted to perform, or assist in performing, the method of claim 16.
